(19) United States
(12) Patent Application Publication
(10) Pub. No.: US 2012/0133664 A1
(43) Pub. Date: May 31, 2012

(54) SYSTEM AND METHOD FOR PAINTERLY RENDERING BASED ON IMAGE PARSING

(75) Inventors: SONG-CHUN ZHU, LOS ANGELES, CA (US); MINGTIAN ZHAO, LOS ANGELES, CA (US)

(73) Assignee: LOTUS HILL INSTITUTE FOR COMPUTER VISION AND INFORMATION SCIENCE, Wuhan (CN)

(21) Appl. No.: 13/304,081

(22) Filed: Nov. 23, 2011

Related U.S. Application Data
(60) Provisional application No. 61/417,660, filed on Nov. 29, 2010.

(51) Int. Cl. G09G 5/00

(52) U.S. Cl. 345/582

(57) ABSTRACT

A system and method for synthesizing painterly-looking images from input images (e.g., photographs). An input image is first interactively decomposed into a hierarchical representation of its constituent components named parse tree, whose nodes correspond to regions, curves, and objects in the image, with occlusion relations. According to semantic information in the parse tree, a sequence of brush strokes is automatically prepared according a brush dictionary manually built in advance, with their parameters in geometry and appearance appropriately tuned, and blended onto the canvas to generate a painterly-looking image.

### REFERENCES

### U.S. Patent Documents

U.S. Pat. No. 7,567,715 B1 7/2009 Zhu et al. 382/232

### REFERENCES

### Other Publications

H. Chen and S.-C. Zhu, “A generative sketch model for human hair analysis and synthesis”, IEEE Trans. Pattern Anal. Mach. Intell. 28, 7, 1025-1040, 2006.
N. S.-H. Chu and C.-L. Tai, “Moxi: Real-Time ink dispersion in absorbent paper”, ACM Trans. Graph. 24, 3, 504-511, 2005.
C. J. Curtis, S. E. Anderson, J. E. Seims, K. W. Fleischer, and D. H. Salesin, “Computer-Generated watercolor”, In Proceedings of the 24th Annual Conference on Computer Graphics and Interactive Techniques (SIGGRAPH '97), 421-430, 1997.
B. S. Funch, The Psychology of Art Appreciation, Museum Tusculanum Press, 1997.
A. Gooch, B. Gooch, P. Shirley, and E. Cohen, “A non-photorealistic lighting model for automatic technical illustration”, In Proceedings of the 25th Annual Conference on Computer Graphics and Interactive Techniques (SIGGRAPH '98), 447-452, 1998.
B. Gooch, G. Coombe, and P. Shirley, “Artistic vision: Painterly rendering using computer vision techniques”, In Proceedings of the 2nd International Symposium on Non-Photorealistic Animation and Rendering (NPAR '02), 83-90, 2002.
B. Gooch and A. Gooch, Non-Photorealistic Rendering, A K Peters, Ltd., 2001.
B. Gooch, P.-P. J. Sloan, A. Gooch, P. Shirley, and R. Riesenfeld, “Interactive technical illustration”, In Proceedings of the 1999 Symposium on Interactive 3D Graphics (I3D '99), 31-38, 1999.
C.-E. Guo, S.-C. Zhu, and Y. N. Wu, “Primal sketch: Integrating structure and texture”, Comput. Vis. Image Understand. 106, 1, 5-19, 2007.
P. Haeberli, “Paint by numbers: Abstract image representations”, In Proceedings of the 17th Annual Conference on Computer Graphics and Interactive Techniques (SIGGRAPH '90), 207-214, 1990.

A. Hertzmann, “Painterly rendering with curved brush strokes of multiple sizes”, In Proceedings of the 25th Annual Conference on Computer Graphics and Interactive Techniques (SIGGRAPH '98), 453-460, 1998.
A. Hertzmann, “Tutorial: A survey of stroke-based rendering”, IEEE Comput. Graph. Appl. 23, 4, 70-81, 2003.
A. Hertzmann, C. E. Jacobs, N. Oliver, B. Curless, and D. H. Salesin, “Image analogies”, In Proceedings of the 28th Annual Conference on Computer Graphics and Interactive Techniques (SIGGRAPH '01), 327-340, 2001.
F.-F. Li, R. Fergus, and A. Torralba, “Recognizing and learning object categories”, A short course at ICCV '05, 2005.
Y. Li, J. Sun, C.-K. Tang, and H.-Y. Shum, “Lazy snapping”, ACM Trans. Graph. 23, 3, 303-308, 2004.
P. Litwinowicz, “Processing images and video for an impressionist effect”, In Proceedings of the 24th Annual Conference on Computer Graphics and Interactive Techniques (SIGGRAPH '97), 407-414, 1997.
D. G. Lowe, “Object recognition from local scale-invariant features”, In Proceedings of the International Conference on Computer Vision (ICCV '99), Volume 2, 1150-1157, 1999.
D. Marr, Vision: A Computational Investigation into the Human Representation and Processing of Visual Information, W.H. Freeman, 1982.
P. Perona, “Orientation diffusions”, IEEE Trans Image Process. 7, 3, 457-467, 1998.
E. Reinhard, M. Ashikhmin, B. Gooch, and P. Shirley, “Color transfer between images”, IEEE Comput. Graph. Appl. 21, 5, 34-41, 2001.
M. C. Sousa and J. W. Buchanan, “Computer-Generated graphite pencil rendering of 3d polygonal models”, In Proceedings of Euro Graphics '99 Conference, 195-207, 1999.
S. Strassmann, “Hairy brushes”, In Proceedings of the 13th Annual Conference on Computer Graphics and Interactive Techniques (SIGGRAPH '86), 225-232, 1986.
T. Strothotte and S. Schlechtweg, Non-Photorealistic Computer Graphics: Modeling, Rendering and Animation, Morgan Kaufmann, 2002.
D. Teece, “3d painting for non-photorealistic rendering”, In ACM Conference on Abstracts and Applications (SIGGRAPH '98), 248, 1998.
Z. Tu, X. Chen, A. L. Yuille, and S.-C. Zhu, “Image parsing: Unifying segmentation, detection, and recognition”, Int. J. Comput. Vis. 63, 2, 113-140, 2005.
Z. Tu and S.-C. Zhu, “Parsing images into regions, curves, and curve groups”, Int. J. Comput. Vis. 69, 2, 223-249, 2006.
G. Turk and D. Banks, “Image-Guided streamline placement”, In Proceedings of the 23rd Annual Conference on Computer Graphics and Interactive Techniques (SIGGRAPH '96), 453-460, 1996.
G. Winkenbach and D. H. Salesin, “Computer-Generated pen-and-ink illustration”, In Proceedings of the 21st Annual Conference on Computer Graphics and Interactive Techniques (SIGGRAPH '94), 91-100, 1994.
S. Xu, Y. Xu, S. B. Kang, D. H. Salesin, Y. Pan, and H.-Y. Shum, “Animating Chinese paintings through stroke-based decomposition”, ACM Trans. Graph. 25, 2, 239-267, 2006.
B. Yao, X. Yang, and S.-C. Zhu, “Introduction to a large-scale general purpose ground truth database: Methodology, annotation tool and benchmarks”, In Proceedings of the International Conferences on Energy Minimization Methods in Computer Vision and Pattern Recognition (EMMCVPR '07), 169-183, 2007.

### BACKGROUND OF THE INVENTION

Painterly rendering refers to a family non-photorealistic computer graphics techniques developed to synthesize painterly-looking images (see the introductory books by Gooch and Gooch, Non-Photorealistic Rendering, A K Peters, Ltd., 2001, and Strothotte and Schlechtweg, Non-Photorealistic Computer Graphics: Modeling, Rendering and Animation, Morgan Kaufmann, 2002), usually from input images (e.g., photographs), and sometimes from 3-D geometric models. Among painterly rendering techniques, there is a method named stroke-based rendering (see the survey by Hertzmann, “Tutorial: A survey of stroke-based rendering”, IEEE Comput. Graph. Appl. 23, 4, 70-81, 2003), which synthesizes image through the composition of certain graphical elements (customarily called brush strokes). Stroke-based rendering involves two main problems:
1. How to model and manipulate brush stroke elements on computers, including parameters of their geometry and appearance?
2. How to design an appropriate sequence of brush strokes according to the input image, including transformation parameters of each stroke, and blend them to synthesize a painterly-looking image?
   For the first problem, previous solutions can be roughly categorized into two streams:
1. Physically based or motivated methods, which simulate the physical processes involved in stroke drawing or painting. While being able to simulate very complex processes in theory, these methods are usually greatly expensive both computationally and manipulatively.
2. Image-based methods, which use brush stroke elements with little or no physical justification. These methods are usually fast, but so far lack an explicit model to simulate different types of brush strokes as well as various drawing or painting strategies used by artists.
   For the second problem, efforts to automatic stroke selection, placement, and rendering are devoted in two directions:
1. Greedy methods, which process and render brush strokes step-by-step, to match specific targets in each single step defined by local objective functions, with or without random factors.
2. Optimization methods, which compute the entire stroke sequence by optimizing or approximating certain global objective functions, then render them in batch mode.
   But still, both methods do not have explicit solutions for the variety in drawing or painting.

This common weakness of all previous methods is partially due to the lack of one key feature. These stroke-based rendering methods, and non-photorealistic rendering techniques in general, typically lack semantic descriptions of the scenes and objects of input images (i.e., what are there in the images and where are them), while such semantics obviously play a central role in most drawing and painting tasks, as commonly depicted by artists and perceived by audiences (see further introductions by Funch, “The Psychology of Art Appreciation”, Museum Tusculanum Press, 1997). Without image semantics, these rendering algorithms capturing only low-level image characteristics (e.g., colors and textures) are doomed to failure in well simulating the usually greatly flexible and object-oriented techniques of artistic drawing and painting. Accordingly, what is desired is a semantics-driven approach, which takes advantage of the rich knowledge of the contents of input images and applies them in painterly rendering.

### SUMMARY OF THE INVENTION

According to one embodiment, the present invention is directed to a system and method for semantics-driven painterly rendering. The input image is received under control of a computer. It is then interactively parsed into a parse tree representation. A sketch graph and an orientation field is automatically computed and attached to the parse tree. A sequence of brush strokes are automatically selected from a brush dictionary according to information in the parse tree. A painterly-looking image is then automatically synthesized by transferring and synthesizing the brush stroke sequence according to information in the parse tree, including the sketch graph and the orientation field, and output under control of the computer.

According to one embodiment of the invention, the parse tree is a hierarchical representation of the constituent components (e.g., regions, curves, objects) in the input image, with its root node corresponding to the whole scene, and its leaf nodes corresponding to the atomic components under a certain resolution limit. There is an occlusion relation among the nodes, in the sense that some nodes are closer to the camera than the others.

According to one embodiment of the invention, the parse tree is extracted in an interactive manner between the computer and the user, via a graphical user interface. Each node in the parse tree is obtained through an image segmentation, object recognition, and user correction process.

According to one embodiment of the invention, the sketch graph correspond to the boundaries between different regions/objects and the structural portion of the input image.

According to one embodiment of the invention, the orientation field is defined on the image pixels, including the two dimensional orientation information of each pixel.

According to one embodiment of the invention, the brush dictionary is a collection of different types of brush stroke elements, stored in the form of images including appearance information of color, opacity and thickness, with attached geometric information of shape and backbone polyline. The brush dictionary is pre-collected with the help of professional artists.

According to one embodiment of the invention, the transfer of brush strokes before their synthesis into the painterly-looking image includes geometric transfer and color transfer. Geometric transfer puts the brush strokes at designed positions and matches the them with the local pattern of sketch graph and orientation field. Color transfer matches the brush strokes with the color of the input image at their positions.

According to one embodiment of the invention, then synthesis of brush strokes include blending their colors, opacities and thickness, and applying shading based on certain illumination conditions.

The details and advantages of the present invention will be better understood with the accompanying drawings, the detailed description, and the appended claims. The actual scope of the invention is defined by the appended claims.

### BRIEF DESCRIPTION OF THE DRAWINGS

FIG. 1 is the flowchart of the system and method of the present invention;

FIG. 2A illustrates a parse tree representation of an example image (a photograph);

FIG. 2B illustrates an occlusion relation among nodes corresponding to the parse tree in FIG. 2A, with layer compression to limit the total number of layers to four;

FIG. 3A illustrates a sketch graph corresponding to the input image and parse tree in FIG. 2A;

FIG. 3B illustrates an orientation field corresponding to the sketch graph in FIG. 3A;

FIG. 4 illustrates some examples from the brush dictionary;

FIG. 5 illustrates an example of color transfer of an brush stroke into different target colors;

FIG. 6 is an example of the painterly rendering result corresponding to the input image in FIG. 2A.

### DETAILED DESCRIPTION

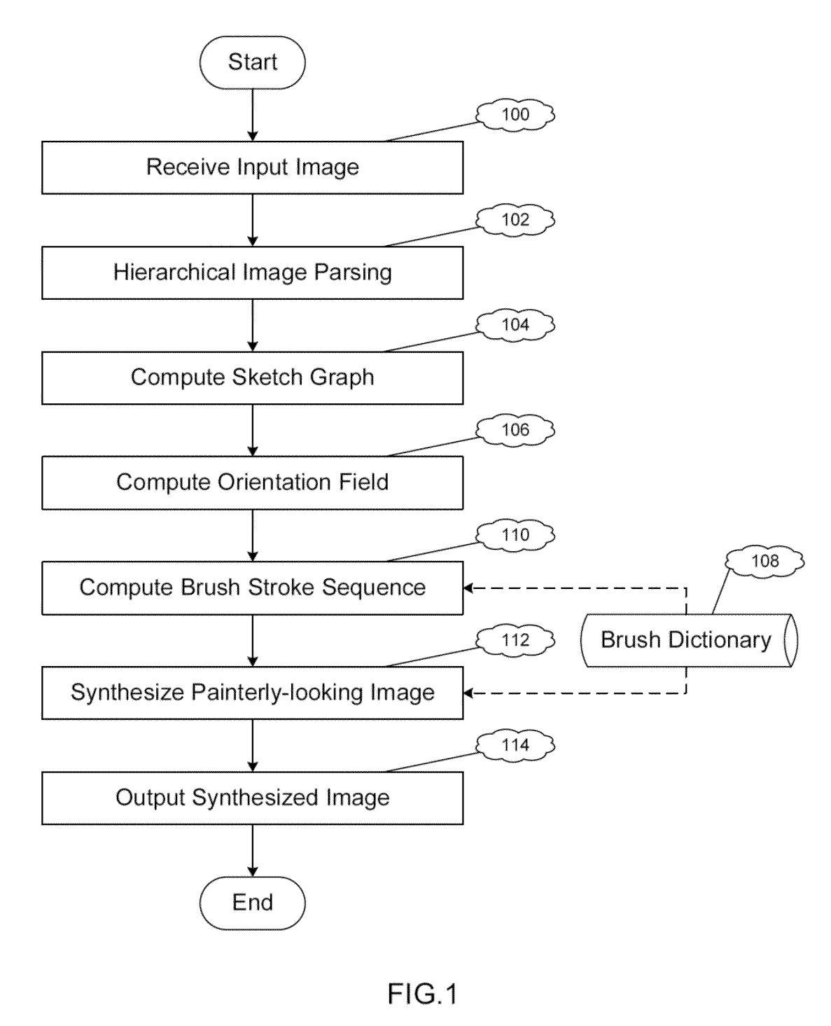

FIG. 1 illustrates the flowchart of the system and method of the present invention. The input image first goes through a hierarchical image parsing phase, in which it is decomposed into a coarse-to-fine hierarchy of its constituent components in a parse tree representation, and the nodes in the parse tree correspond to a wide variety of visual patterns in the image, including:

1. generic texture regions for sky, water, grass, land, etc.;

2. curves for line or threadlike structures, such as tree twigs, railings, etc.;

3. objects for hair, skin, face, clothes, etc.

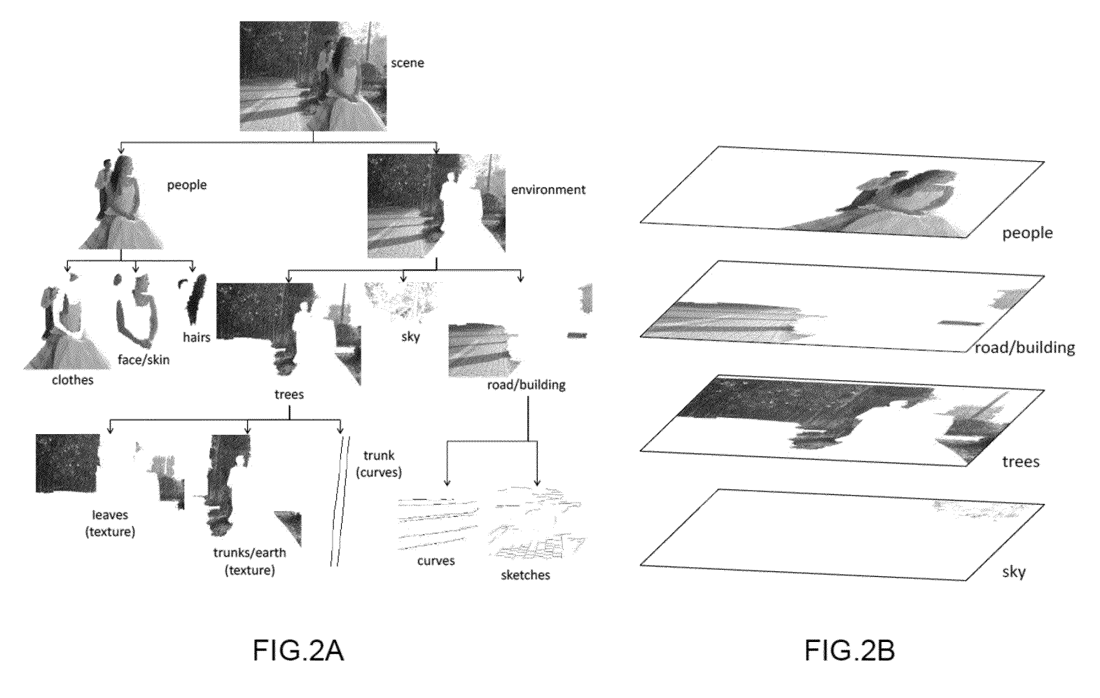

FIG. 2A shows an example of hierarchical image parsing. The whole scene is first divided into two parts: two people in the foreground and the outdoor environment in the background. In the second level, the two parts are further subdivided into face/skin, clothes, trees, road/building, etc. Continuing with lower levels, these patterns are decomposed recursively until a certain resolution limit is reached. That is, certain leaf nodes in the parse tree become unrecognizable without the surrounding context, or insignificant for specific drawing/painting tasks.

Given an input image, let W be the parse tree for the semantic description of the scene, and

[symbol]

={Rₖ:i=1,2, . . . , K}⊂W (1)

be the set of the K leaf nodes of W, representing the generic regions, curves, and objects in the image. Each leaf node Rₖ is a 3-tuple

Rₖ= [symbol] Λₖ,lₖ, [symbol] ₖ [symbol] , (2)

where Λₖ is the image domain (a set of pixels) covered by Rₖ, and lₖ and [symbol] ₖ are its label (for object category) and appearance model, respectively. Let A be the domain of the whole image lattice, then

Λ=Λ₁∪Λ₂∪ . . . ∪Λ_{K} (3)

in which it is not demanded that Λᵢ∩Λⱼ= for all i≠j since two nodes are allowed to overlap with each other.

The leaf nodes [symbol] can be obtained with a segmentation and recognition (object classification) process, and assigned to different depths (distances from the camera) to form a layered representation of the scene structure of the image. In step 102, a three-stage, interactive process is applied to acquire the information:
1. The image is segmented into a few regions (e.g., using the algorithm of Li et al., “Lazy snapping”, ACM Trans. Graph. 23, 3, 303-308, 2004) in a real-time interactive manner using foreground and background scribbles.
2. The regions are classified by an object category classifier (e.g., Li et al., “Recognizing and learning object categories”, A short course at ICCV '05, 2005) into pre-defined categories, e.g., human face, sky, water surface, flower, grass, etc. In case of imperfect recognitions, the user can correct the category labels through the software interface by selecting from a list of all the category labels.
3. The regions are assigned to layers of different depths by maximizing the probability of a partially ordered sequence

S:R₍₁₎ [symbol] R₍₂₎ [symbol] . . . [symbol] R_{(K)} (4)
for region R₍₁₎ in the same or closer layers of R₍₂₎ through R_{(K)}, which is a permutation of

R₁ [symbol] R₂ [symbol] . . . [symbol] R_{K} (5)

Assuming all events R₍ₖ₎ [symbol] R₍ₖ₊₁₎, k=1, 2, . . . , K−1 are independent, an empirical approximate solution is

$$\begin{matrix}{S}^{*} = arg {max}_{S} p ( {R}_{( 1 )} {R}_{( 2 )} , {R}_{( 2 )} {R}_{( 3 )} , … , {R}_{( K - 1 )} {R}_{( K )} ) \\ = arg {max}_{S} {\prod }_{k = 1}^{K - 1} p ( {R}_{( k )} {R}_{( k + 1 )} )\end{matrix} \qquad ( 6 )$$

in which the probability p(R₍ₖ₎ [symbol] R₍ₖ₊₁₎) is approximated with

p(R₍ₖ₎ [symbol] R₍ₖ₊₁))≈\tilde{f}(Rᵢ [symbol] Rⱼ[lᵢ=l₍ₖ₎,lⱼ=l₍ₖ₊₁₎), (7)

where \tilde{f} returns the frequencies of occlusions between different object categories according to certain previously annotated observations (e.g., in the LHI image database, Yao et al., “Introduction to a large-scale general purpose ground truth database: Methodology, annotation tool and benchmarks”, In Proceedings of the International Conferences on Energy Minimization Methods in Computer Vision and Pattern Recognition (EMMCVPR '07), 169-183, 2007). Once S* is obtained, the user can also correct it by swapping pairs of regions through the software interface, and can further compress the sequence to limit the total number of layers, by combining the pairs of R₍ₖ₎ and R₍ₖ₊₁₎ with relatively low p(R₍ₖ₎ [symbol] R₍ₖ₊ₚ₎), as shown in FIG. 2B.

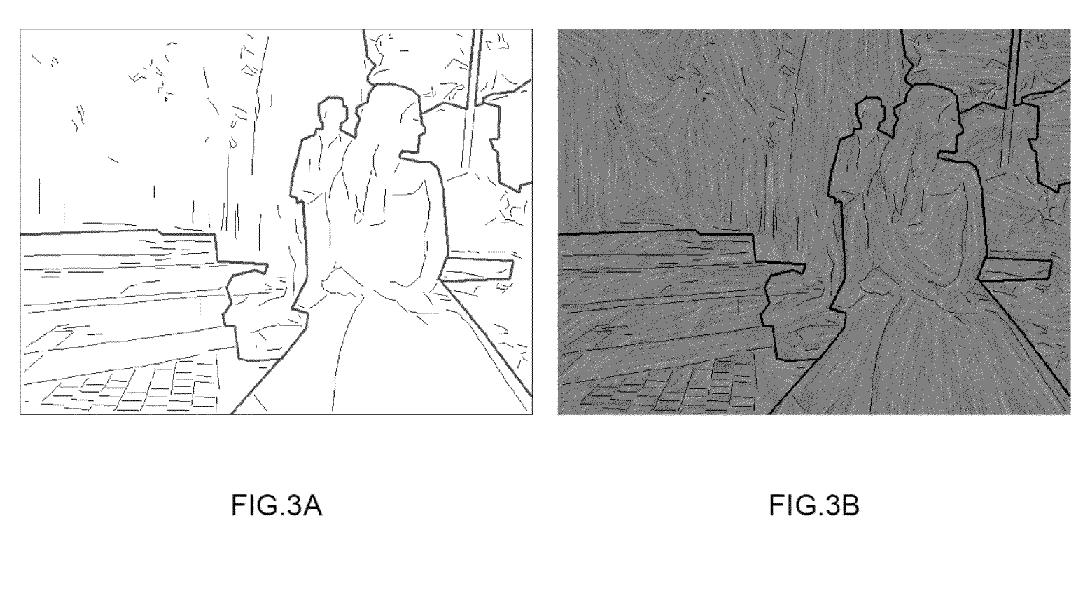

In step 104, a sketch graph is computed for each leaf node (except curves) in the parse tree, by running an image sketching algorithm (e.g., the primal sketch algorithm, Guo et al., “Primal sketch: Integrating structure and texture”, Comput. Vis. Image Understand. 106, 1, 5-19, 2007). These sketch graphs, along with the segmentation boundaries obtained in step 102, are combined to generate a sketch graph for the whole input image, as shown in FIG. 3A.

In step 106, an orientation field is computed for each leaf node (except curves) in the parse tree using the following process. Given the domain Λₖ of a leaf node Rₖ, the sketch graph and the segmentation boundary correspond to a structural part Λₖ^{structural}, while the rest pixels correspond to a textural part Λₖ^{textural}, with

Λₖ=Λ_{structural}∪Λₖ^{textural},Λₖ^{structural}∩Λₖ^{textural}=. (8)

The structural part provides major pixel orientation information of the image, as shown in FIG. 3A, so an orientation field on Λₖ is computed by minimizing an Markov random field (MRF) energy defined with pair cliques in a 3-layer neighborhood system. An orientation field Θₖ of Rₖ, defined on Λₖ, is the set of orientations at every pixel sεΛₖ

Θₖ={θ(s):θ(s)ε[0,π),sεΛₖ} (9)

in which each orientation θ(s) depends on its neighbors in three layers:
1. The same pixel s in the initial orientation field

Θₖ^{structural}={θ(s):θ(s)ε[0,π),sεΛₖ^{sructural}} (10)
covering all pixels in the structural part of Rₖ;
2. The adjacent pixels ∂s of s on the 4-neighborhood stencil of the orientation field Θₖ;
3. The same pixel s in the prior orientation field

Θₖ^{prior}={θ(s):θ(s)˜G(μₖ,θₖ²,aₖ,bₖ),sεΛₖ} (11)
of Rₖ, in which G(μₖ, θₖ², aₖ, bₖ) is a truncated Gaussian distribution whose parameters depend on the properties of Rₖ and are assigned in advance by the user.
   Corresponding to the constraints of the three layers, the energy function of the orientation field is defined as

E(Θₖ)=E_{structural}(Θₖ+Eₛₘₒₒₜₕ(Θₖ)+βEₚᵣᵢₒᵣ(Θₖ) (12)

in which E_{structural}(Θₖ), Eₛₘₒₒₜₕ(Θₖ) and Eₚᵣᵢₒᵣ(Θₖ) are terms for the aforementioned three layers, respectively, and α and β are weight parameters assigned by the user. The first term

$${E}_{structural} ( {Θ}_{k} ) = {\sum }_{s ∈ {Λ}_{k}^{s}} d ( {Θ}_{k} ( s ) , {Θ}_{k}^{structural} ( s ) ) {ρ}_{k}^{structural} ( s ) \qquad ( 13 )$$

measures the similarity of Θₖ and Θₖ^{structural} at sketchable pixels, in which the weight map structural

ρₖ^{structural}={ρ(s):ρ(s)=∇_{⊥Θ}_{ₖ}^{structural}I_{Λ}_{ₖ}^{structural}} (14)

is a gradient strength field across the sketches, and d is a distance function between two orientations defined on [0,π)×[0,π) as

d(θ,φ)=sin|θ−φ|. (15)

The smoothing term

$${E}_{smooth} ( {Θ}_{k} ) = {\sum }_{〈 s , t 〉} d ( {Θ}_{k} ( s ) , {Θ}_{k} ( t ) ) \qquad ( 16 )$$

measures the similarity between adjacent pixels s and t in Θₖ, and the prior term is similarly defined homogeneously as

$${E}_{prior} ( {Θ}_{k} ) = {\sum }_{s ∈ {Λ}_{k}} d ( {Θ}_{k} ( s ) , {Θ}_{k}^{prior} ( s ) ) \qquad ( 17 )$$

to apply additional preferences to pixel orientations in Θₖ, which is especially useful for regions with weak or even no data constraint of Θₖ^{structural} such as a clear sky.

A diffusion algorithm (e.g., Perona, “Orientation diffusions”, IEEE Trans Image Process. 7, 3, 457-467, 1998) can be applied to minimize E(Θₖ) for the objective Θₖ. With Θₖ, k=1, 2, . . . , K, the orientation field Θ of the whole image is eventually computed with

Θ=Θ₁∪Θ₂∪ . . . ∪Θ_{K}. (18)

FIG. 3B visualizes, by linear integral convolution (LIC), an orientation field generated with the sketch graph in FIG. 3A, where the Gaussian prior energy is disabled for clarity. With the above layered representation and algorithms, the generated orientation field is determined by only local sketches and boundaries within each region, thus it prevents abnormal flows along boundaries between adjacent regions caused by occlusion, for example, the background flows around the contour of the two people in the example shown in FIG. 3B.

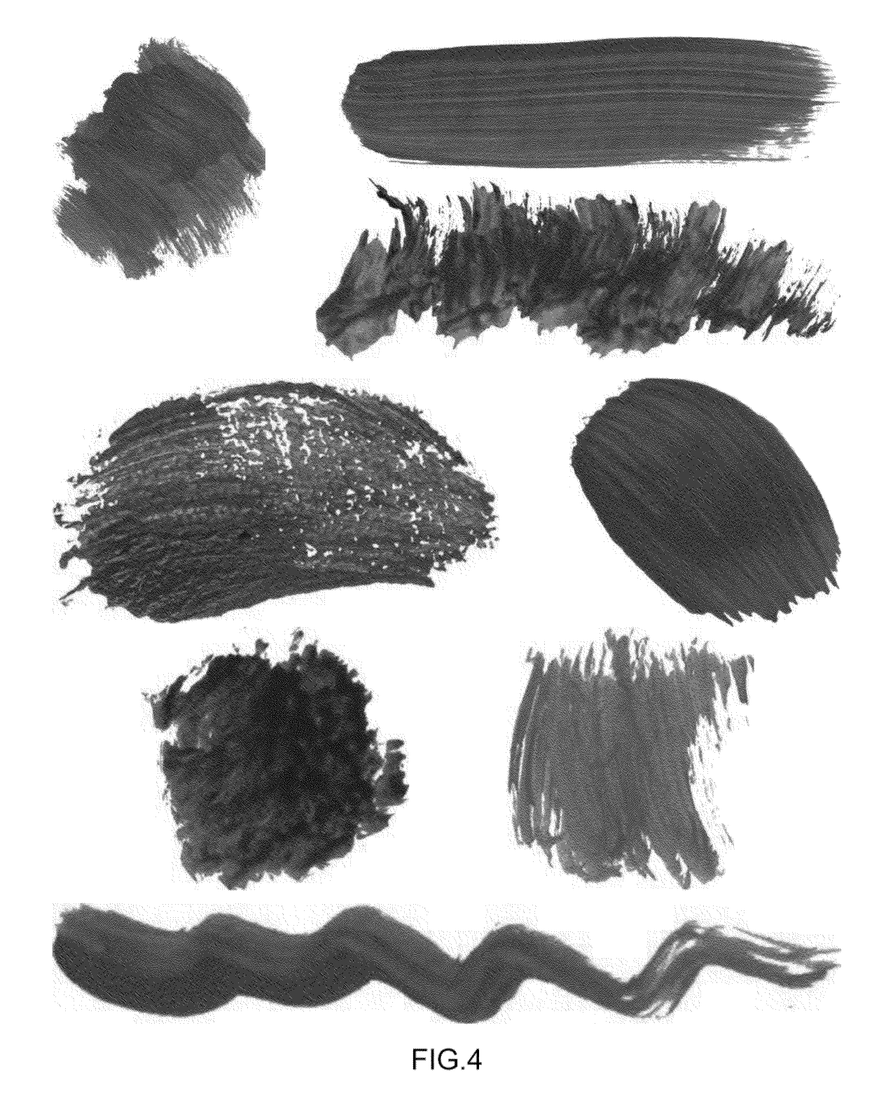

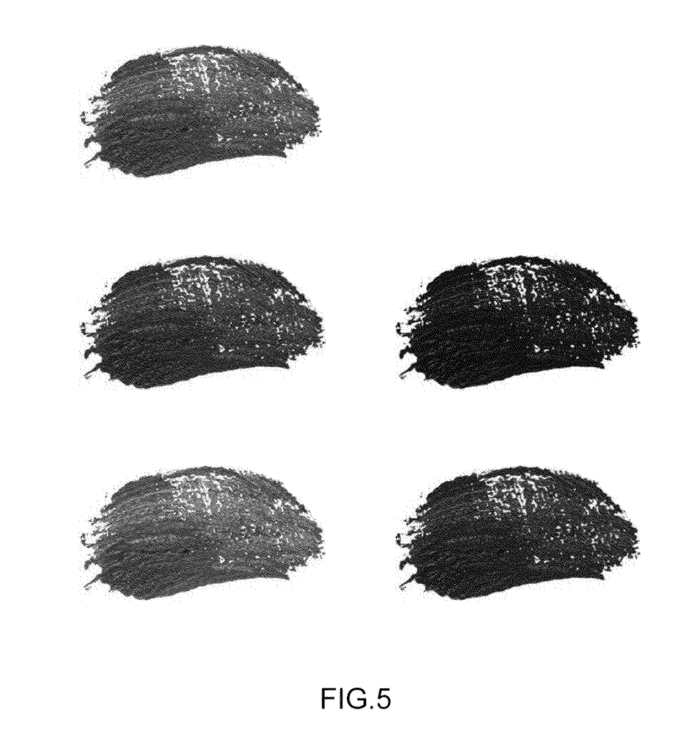

In step 108, an image-example-based brush dictionary is pre-collected with the help of professional artists. Some examples from the dictionary are shown in FIG. 4. Brushes in the dictionary are of four different shape/appearance categories: point (200 examples), curve (240 examples), block (120 examples) and texture (200 examples). Approximate opacity and height maps are manually produced for the brushes using image processing softwares according to pixels' gray levels. Backbone polylines are also manually labeled for all brushes. With variations in detailed parameters, these brushes reflect the material properties and feelings in several perceptual dimensions or attributes, for example, dry vs. wet, hard vs. soft, long vs. short, etc. Original colors of the brushes in the dictionary are close to green. During the rendering process, they will be dynamically transferred to expected colors, using a color transfer algorithm (similar to Reinhard, “Color transfer between images”, IEEE Comput. Graph. Appl. 21, 5, 34-41, 2001). The color transfer operation takes place in the HSV color space to keep the psychological color contrast during the transfer. Since the pixels within a brush image is nearly monotone in contrast to the colorfulness of common natural images, this algorithm capturing only means and variances of colors works quite well, as shown in FIG. 5. For each brush in the dictionary, its opacity and height maps are available in addition to the shape and color information, allowing painting with different blending methods according to properties of target regions, as well as photorealistic shading effects.

In step 110, a layered stroke placement strategy is adopted. During the rendering process, the algorithm starts from the most distant layer, and move backwards to the foreground layer. Then the whole stroke placement sequence is determined by the sequences for the layers. For each layer, two types of strokes are used for the processing of curves and regions, respectively. Usually, strokes for curves are placed upon (or after, in time) strokes for regions for an occlusion effect. For example, long strokes for twigs are placed upon texture strokes for the background sky.

The strokes for curves are placed along the long and smooth curves in the sketch graph (see FIG. 3A), with morphing operations to bend the brush backbones as well as the attached color pixels according to curve shapes. As for the strokes for regions, a simple greedy algorithm is used for determining the sequence of placement. For each region in a specific layer, these steps are followed:
1. Construct a list q to record pixel positions. Randomly select an unprocessed pixel s in this region, and add s to q;
2. According to the orientation Θ(s) of s, find pixel t in its 8-neighborhood using

t=s+(sign[cos Θ(s)],sign[sin Θ(s)]); (19)
3. If cos(Θ(s)−Θ(t))>1/\sqrt{2}, add t to q, then let s=t and go to step 2, otherwise go to step 4;
4. Now q contains a list of pixels, which trace the orientation flow to form a streamline. According to the shape and length of the streamline, as well as the object category of the current region, we randomly select a brush B from a set of candidates from the dictionary, then calculate the geometric transformation T to adapt the backbone of B to the streamline. Add stroke [symbol] B,T [symbol] to the stroke sequence for the current region, and mark all pixels covered by this stroke as processed;
5. Stop if all the pixels in the current region are processed, otherwise go to step 1.
   In order to complete these steps to fulfill the stroke placement task, a few details need to be specified:
1. In real applications, an orientation field with lower resolution than the original image is preferred, and the maximum size of list q is limited according to the object category and/or user preferences. The limit depends on the resolution of the discrete orientation field, which corresponds to the size of the result image;
2. To construct the set of candidate brushes from the dictionary, the mapping relations between brushes and object categories of regions are hard-coded in advance. Specifically, the four brush categories are divided into more small groups according to the length/width ratios of the brushes, and define probabilities for selection over these groups for each object category. The candidate set is obtained by sampling from the corresponding distribution according to the object category of the region. For example, for an image region labeled as “human face”, higher probabilities are assigned for block brushes with relatively smaller length/width ratios in the dictionary, than the probabilities for very long block brushes and dot, curve and texture brushes;
3. To select from the candidate set of brushes, the shape parameters are obtained from the traced streamline. The brush that requires the minimum warping and scaling to fit the streamline is selected. To achieve this, a common basis representation for both the backbones of the brushes and the streamlines is adopted. The backbones and streamlines are fitted with polynomial curves up to the fourth order. Then the difference between the streamline and the backbones can be described by the difference between the coefficients of the polynomials, where low order coefficients are weighed more to emphasize the global shape of the brush stroke. Finally, the brush is selected by minimizing this difference.

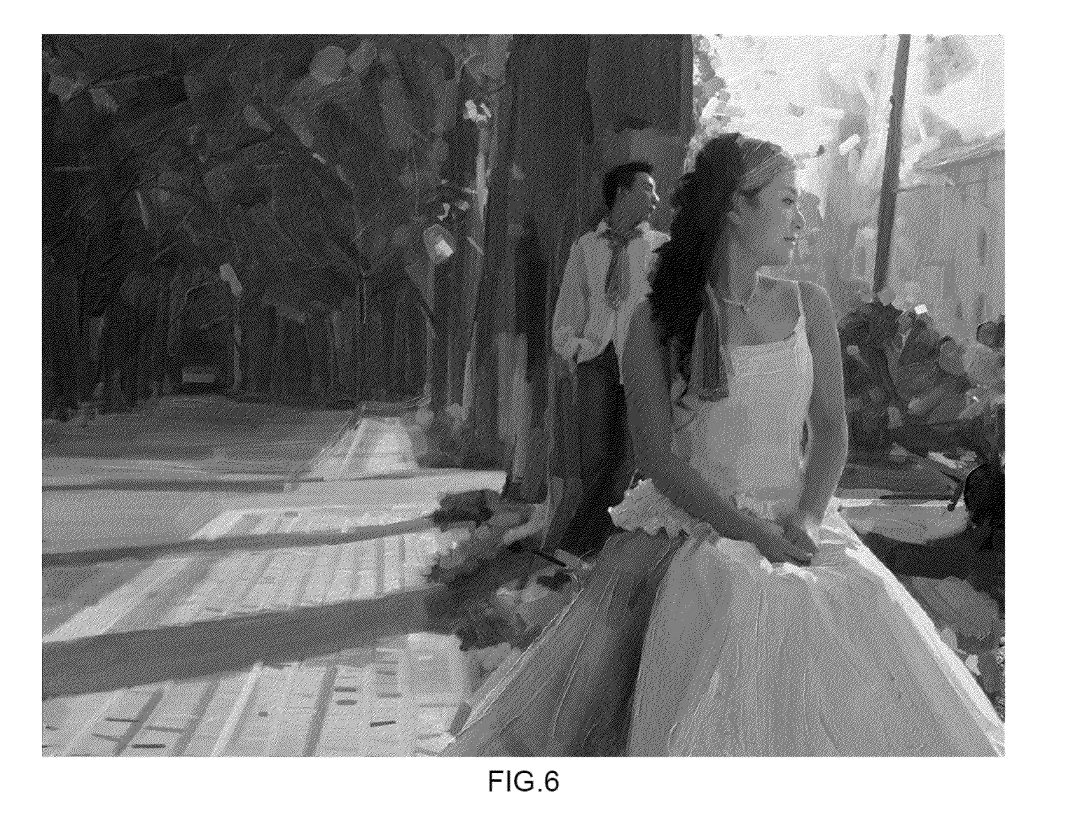

In step 112, after the stroke sequence is determined, the renderer synthesizes the painting image using the high resolution images from the brush dictionary. Objective colors for color transfer are obtained by averaging over a few random samples from corresponding areas in the source image. This method may cause loss of fidelity in gradually changing colors, but it is not a problem due to the fact that the existence of color blocks is one of the observable features of paintings. Depending on the object category of the current region, colors from different brush strokes may be blended using designed strategies, for example, with opacity between zero and one for “human face” and “sky”, or without it (i.e., one brush completely covers another) for “flower” and “grass”. Meanwhile, a height map for the region is constructed according to brush properties, for example, the height map accumulates with dry brushes but not with wet brushes. In the end, the photorealistic renderer performs shading with local illumination for the painting image according to the height map. An example result is shown in FIG. 6.

1. A computer-implemented method for painterly rendering taking advantage of semantics information of input images, the method comprising:
receiving the input image under control of the computer;
interactively parsing the image into a hierarchical representation named parse tree;
automatically computing a sketch graph and a orientation field of the image and attaching them to the parse tree;
automatically selecting a sequence of brush strokes from a brush dictionary according to information in the parse tree;
automatically synthesizing a painterly-looking image using the brush stroke sequence according to information in the parse tree; and
outputting the synthesized image under control of the computer.

2. The method of claim 1, wherein the parse tree is a hierarchical representation of the constituent components (e.g., regions, curves, objects) in the input image, with its root node corresponding to the whole scene, and its leaf nodes corresponding to the atomic components under a certain resolution limit.

3. The method of claim 2, wherein the parse tree is extracted from the input image in an interactive manner between the computer and the user via a graphical user interface. Node in the parse tree is obtained through interactive segmentation of the image into regions, classification of the regions for their object category labels using machine learning algorithms, and interactive user correction to correct imperfect classification results.

4. The method of claim 1, wherein the nodes in the parse tree have occlusion relations with each other in the form of an occlusion sequence, in which each node is in the same or closer layers of all nodes after it in the sequence.

5. The method of claim 4, wherein the occlusion sequence is obtained by maximizing it probability which is a product of empirical frequencies of pairwise occlusions in a human annotated reference database.

6. The method of claim 1, wherein the sketch graph, in a discrete form, is a set of pixels belonging to either the segmentation boundaries between different regions/objects, or the structural portion of the image corresponding to salient line and curve segments obtained using image sketching algorithms.

7. The method of claim 1, wherein the orientation field is defined on image pixels, with data of the two dimensional orientation information of the pixels.

8. The method of claim 7, wherein the orientation field is computed by minimizing a Markov random field (MRF) energy function, including a data term corresponding to the sketch graph, a smoothness term forcing the orientation of a pixel to be similar to its neighboring pixels, and a prior term corresponding to the object category label.

9. The method of claim 1, wherein the brush dictionary is a collection of different types of brush stroke elements stored in an image-example-based format. Each brush stroke element in the dictionary has a color map, an opacity map, and a thickness map. Each element also has attached geometric information of its shape and backbone polyline.

10. The method of claim 1, wherein a sequence of brush strokes is selected from the brush dictionary using a greedy algorithm, considering information including object categories of the nodes in parse tree, the sketch map, and the orientation field.

11. The method of claim 1, wherein the synthesis of brush strokes into the painterly-looking image includes processes for both geometric transfer and color transfer.

12. The method of claim 11, wherein the geometric transfer puts the brush strokes at desired positions on canvas, and matches them with either the streamline traced in the orientation field (for nodes corresponding to generic regions or objects), or the sketch graph (for nodes corresponding to curves).

13. The method of claim 11, wherein the color transfer matches the brush strokes with the local color pattern of the input image at their positions.

14. The method of claim 1, wherein the synthesis of brush strokes into the painterly-looking image also includes the blending their colors, opacities and thickness, and applying shading based on certain illumination conditions.
